(19) United States
(12) Patent Application Publication
(10) Pub. No.: US 2016/0104082 A1
(43) Pub. Date: Apr. 14, 2016

(54) Healthcare workflow analytics

(71) Applicant: Intelligent InSites, Inc., Fargo, ND (US)

(72) Inventors: Trevor Gruby, Saint Michael, MN (US); Marcus Ruark, Austin, TX (US); Raymond Gruby, Bismarck, ND (US); Eric Novack, Phoenix, AZ (US); Keith Herron, Charlotte, NC (US); Mark Bildeaux, Scranton, PA (US)

(21) Appl. No.: 14/852,436

(22) Filed: Sep. 11, 2015

Related U.S. Application Data
(60) Provisional application No. 62/048,829, filed on Sep. 11, 2014.

(51) Int. Cl. G06Q 10/06

(52) U.S. Cl. CPC G06Q 10/0633; G06Q 50/22

(57) ABSTRACT

Systems and methods that monitor the movement of a patient through the medical treatment process and collect, process, and display various statistics concerning that movement, while also making suggestions that improve patient flow, providing tools to appropriately revise schedules and templates to make future schedules more efficient. Embodiments of the invention treat each patient visit as a multi-stage process and collect information of interest concerning the various stages of the process, such as arrival time, departure time, etc. The collected data may be used to study the treatment process and how it relates to certain individual patients or classes of patients, as well as, e.g., potentially making recommendations to improve the treatment process, modifying future schedules to increase efficiency, making real time optimizations of patient visits, etc.

### CROSS-REFERENCE TO RELATED APPLICATIONS

The present application claims the benefit of co-pending U.S. provisional application No. 62/048,829, filed on Sep. 11, 2014, the entire disclosure of which is incorporated by reference as if set forth in its entirety herein.

### TECHNICAL FIELD

The invention relates generally to methods and systems for improving healthcare treatment, and more specifically to the systems and methods that analyze healthcare workflows for subsequent improvement.

### BACKGROUND

When seeking medical treatment at a facility such as, e.g., a clinic, hospital, urgent care center, or cancer treatment center, patients need to proceed through various procedural steps (for example, registering, updating medical history, etc.) and a number of clinical steps (for example, vital signs measurement, imaging, clinician visit, counseling, etc.) in order to receive treatment.

Each of these steps, procedural or clinical, can take varying amounts of time to complete based upon a wide array of facility, provider, administrative, and patient attributes and needs, depending upon factors that can vary over time. Certain steps must occur in series, while others may occur in parallel or in any order.

These overlapping and sometimes conflicting attributes and needs can hinder or slow the delivery of treatment. Accordingly, there is a need for systems and methods that can help improve the delivery of medical treatment.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments of the present invention relate to systems and methods that monitor the movement of a patient through the medical treatment process and collect, process, and display various statistics concerning that movement, while also making suggestions that improve patient flow, providing tools to appropriately revise schedules and templates to make future schedules more efficient.

Embodiments of the present invention treat each patient visit as a multi-stage process and collect information of interest concerning the various stages of the process, such as arrival time, departure time, etc. The collected data may be used to study the treatment process and how it relates to certain individual patients or classes of patients, as well as, e.g., potentially making recommendations to improve the treatment process, modifying future schedules to increase efficiency, making real time optimizations of patient visits, etc.

In one aspect, embodiments of the present invention relate to a method for analyzing healthcare workflow data. The method includes collecting, via a network interface, healthcare workflow data; receiving, through a user interface, at least one specified attribute; and selecting, from the collected plurality of workflows, each workflow of the plurality associated with a patient having the at least one specified attribute. The healthcare workflow data includes at least one workflow, each workflow associated with a patient, each patient associated with at least one attribute.

In one embodiment, each workflow comprises at least two markers. The method may further include receiving, through a user interface, at least two specified markers. The method may further include computing at least one metric between two specified markers. The method may further include comparing the at least one computing metric against a threshold value. The threshold value may be selected from the group consisting of a normative value and a specified value.

In one embodiment, the method may further include recommending a change to at least one workflow based on the comparison. In one embodiment, the method may further include storing the collected healthcare workflow data in a persistent electronic memory. In one embodiment, the method may further include comparing at least two of the selected plurality of workflows.

In one embodiment, the markers are selected from the group consisting of a time, a place, and a location.

In another aspect, embodiments of the present invention relate to an apparatus for analyzing healthcare workflow data. The apparatus includes a network interface for transmitting and receiving electronic communications; a user interface for accepting user input and providing output to an operator; and a processor communicatively coupled to the user interface and the network interface. The processor is configured to execute instructions from a storage to collect, via the network interface, healthcare workflow data; receive, through a user interface, at least one specified attribute; and select, from the collected plurality of workflows, each workflow of the plurality associated with a patient having the at least one specified attribute. The healthcare workflow data includes at least one workflow, each workflow associated with a patient, each patient associated with at least one attribute.

In one embodiment, each of the collected workflows comprises at least two markers. The processor may be further configured to execute instructions from the storage to receive, through a user interface, at least two specified markers. The processor may be further configured to execute instructions from the storage to compute at least one metric between two specified markers. The processor may be further configured to execute instructions from the storage to compare the at least one computed metric against a threshold value. The threshold value is selected from the group consisting of a normative value and a specified value.

The processor may be further configured to execute instructions from the storage to recommend a change to at least one workflow based on the comparison. The processor may be further configured to execute instructions from the storage to store the collected healthcare workflow data in a persistent electronic memory. The processor may be further configured to execute instructions from the storage to compare at least two of the selected plurality of workflows.

The markers may be selected from the group consisting of a time, a place, and a location.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1 is a diagram of an exemplary course of treatment for a hypothetical patient;

FIG. 2 presents an exemplary analysis of adjacent key markers in FIG. 1 performed by an embodiment of the present invention;

FIG. 3 presents an exemplary analysis of non-adjacent key markers in FIG. 1 performed by an embodiment of the present invention;

FIG. 4 presents an analysis of key markets for patients having a shared attribute performed by an embodiment of the present invention;

FIG. 5 is an example of an analysis of a patient healthcare workflow data set;

FIG. 6 is a diagram of one embodiment of an apparatus for healthcare workflow analysis in accord with the present invention; and

FIG. 7 is a flowchart of a method for healthcare workflow analysis in accord with a present invention.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are the means used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The processes and displays presented herein are not inherently related to any particular computer or other apparatus. Various general purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

### Definitions

For purposes of this application, a “workflow” is any task performed in series or parallel by two or more members of a workgroup to reach a common goal. “Tasks” refers to any activities or actions undertaken by individuals. “Series or parallel” implies tasks performed one after another or simultaneously. “Workgroup” means a team of individuals working on the same project. A “common goal” indicates that a group's various activities are performed in concert and contribute to a well-defined and agreed upon outcome. Finally, a “healthcare workflow” applies the principles of a workflow to the delivery of healthcare.

In accord with various embodiments of the present invention, a facility for medical treatment is equipped to track medical equipment, facility staff, and individual patients as they move throughout the facility and obtain treatment. For example, a patient may be given a pager-like device that permits geopositioning through, e.g., GPS, Wi-Fi based, or active or passive RFID-based location services. In another embodiment, a patient can download an app for installation on a mobile device that leverages the mobile device's existing sensor suite for geopositioning the user. Various kinds of facilities may be so equipped, such as hospital, clinics, remote facilities, telehealth facilities, etc.

In addition to such active positioning measures, embodiments of the present invention can also utilize indirect or manually-entered positioning measures. For example, a phlebotomist in a lab can enter the arrival and/or departure time of a particular patient, which effectively positions the patient in the lab for that time interval. In another embodiment, the creation of a medical record on a device or in a database can, again, be used to infer the position of the patient at a certain point in time. In other embodiments, a patient may manually enter their position at a keypad or a kiosk, or their position may be inferred from, e.g., a motion sensor or a pressure sensor indicating a person entering a room utilized in tandem with an electronic appointment record indicating that the patient is supposed to enter the room at that time. Still other embodiments use real-time sensory data and other contextual data sources to track patient location as patients move throughout the medical facility.

Embodiments of the present invention also track various conditions associated with a particular patient, as courses of treatment will naturally vary among patients having different conditions and meaningful conclusions may be drawn by studying courses of treatment across patients having the same or similar conditions. For example, a patient may be associated with attributes such as “pregnancy,” “diabetes,” “chest pain,” acuity levels, and demographic attributes describing the patient stored in, e.g., an electronic medical records (EMR) system. Other pertinent attributes may concern the nature of the appointment, e.g., “new patient visit—allergy,” “returning patient visit—allergy,” etc. These attributes typically remain constant during a particular course of treatment (e.g., “female”), although they may change during the course of treatment or across various courses of treatment spread out in time (e.g., “pregnant”, “overweight,” etc.).

Each patient's course of treatment can be visualized and treated as a multi-stage workflow having several “markers,” i.e., events happening at certain points in the patient's treatment workflow. Exemplary markers include patient education, X-rays, lab work, vital sign measurement, IV delivery, etc. Some markers may be location-based, such as arriving in or departing from a particular room, or encounter based, such as when a doctor meets with a patient. Markers may be observed in the order in which they occur throughout a visit. Still other markers may concern events that may not be directly related to treatment, such as the construction of a patient's surgical instrument case cart, the delivery of the cart to the operating room, the scheduling of a patient to an operating room, the building of a patient's clinical chart in preparation for surgery, etc.

Markers may be designated manually, as in the case when an analyst is interested in analyzing specific events associated with one or more workflows. Markers may also be designated automatically or prepopulated for common markers of entry, e.g., “arrival time,” “departure time,” “time waiting to meet with physician,” etc.

In some embodiments, markers may be specified in advance and data relevant to the specified markers is subsequently collected. For example, if a marker is associated with the time that a doctor places an order for a lab test or an order for medication, then embodiments of the present invention may obtain the time of that order from the patient's Electronic Health Record (EHR) or other data records within the system; in some cases substantially contemporaneous with the placement of the order by the physician. In other embodiments, various data values are collected ex ante, permitting ex post specification of markers, analysis, and recommendation as discussed herein.

Certain markers may or may not be present in certain workflows, and there can be any number of markers defined. Multiple markers may occur simultaneously or have overlapping durations. Each detected occurrence of a marker is time stamped so that the timing between any two markers or any set of markers can be analyzed. Markers may be applicable to all of the patients visiting a particular medical facility, they may be tailored to particular patients or classes of patients, and in some embodiments can be implemented in workflows occurring across various medical facilities.

Embodiments of the present invention maintain records and data structures sufficient to track each patient's healthcare workflow for later analysis and improvement. In particular, the workflow data may be analyzed to identify impediments or other inefficiencies within the treatment workflow. Other embodiments of the invention analyze workflows concerning personnel treatment, facility asset tracking (rooms, equipment, etc.), etc. but, for convenience, the following discussion assumes a healthcare workflow centered on a patient.

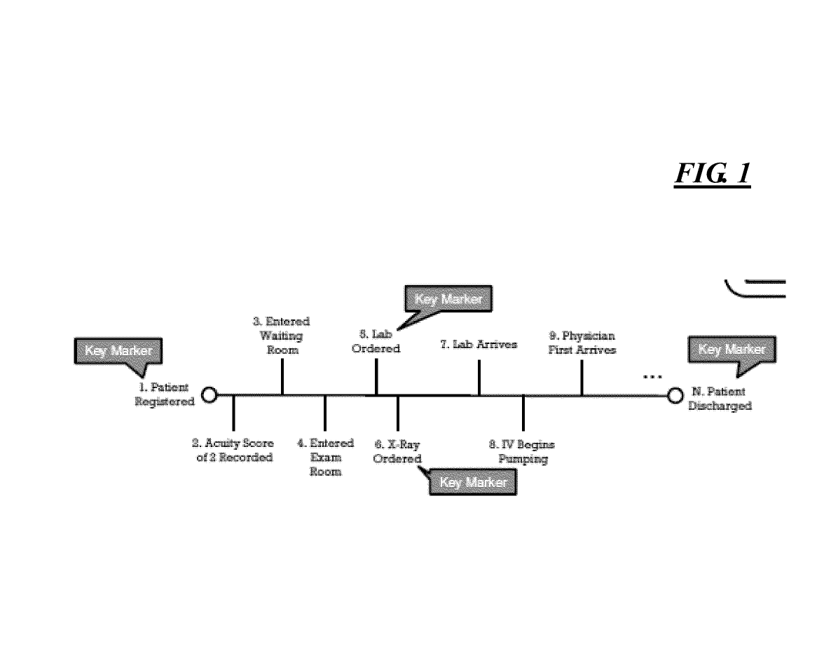

FIG. 1 depicts a course of treatment for a hypothetical patient. The patient is associated with a medical record in a database that indicates that the patient has the attributes “allergy,” “diabetes,” and “pregnancy.” The course of treatment begins with the patient's registration in the facility's front office (Step 1). As discussed above, a clinic employee may interact directly with the system and create a record indicating, e.g., the start and finish of the patient's registration process, or the embodiment may infer the arrival and departure of the patient by monitoring the creation of records in the registration system or tracking the position of a device held by the patient and noting that the device is located near the registration desk in the clinic.

As part of the registration, the patient indicates that she is in pain and that her pain has an acuity level, i.e., an intensity, of two. As that information is entered into the patient's medical record, it is also added as a marker in the data structure corresponding to the patient's workflow (Step 2).

The patient leaves the registration area and enters the waiting room (Step 3). The system tracks the patient's location, either actively or passively, and updates the data structure corresponding to the workflow to add this new marker. When the patient is called and enters the exam room (Step 4), the system notes the change in the patient's location and, again, updates its records to add this new marker.

The health care provider meets with the patient in the exam room and orders various tests for the patient, in this case a lab (Step 5) and an X-ray (Step 6). The nurse practitioner can add these markers directly to the system by, e.g., interacting with an embodiment of the invention using a tablet or smartphone, or the system may add the markers itself by noting the creation of the records in connection with the ordering of the tests and updating the workflow tracking data structures.

This process continues until the patient is discharged from treatment and/or leaves the treatment facility (Step N): the patient moves to another location or undertakes a new step in their treatment process, the system notes the change (actively or passively, as discussed above) and updates the records corresponding to the patient's treatment workflow to note information of interest for each marker such as, e.g., arrival time, departure time, start time, stop time, the identity of the treating personnel, etc. With further reference to FIG. 1, the workflow data is updated to reflect the arrival of the patient's lab work, the start of the IV administration of fluids to the patient, the arrival of the physician and other relevant but non-marker events, etc., until the patient is discharged.

In some embodiments, the treatment workflow data is analyzed while the patient is in the clinic, undergoing his course of care. This permits the issuance of “intelligent alerts” to clinic staff or other users of the system when certain pre-defined criteria are met. These criteria include alerts when, e.g., too many users are waiting for a particular treatment, or a particular user has been waiting for a time exceeding a threshold value. Some embodiments will, in addition, make specific recommendations (e.g., “add another employee to handle patient registration”) or general recommendations (e.g., “current average time for blood lab results exceeds historical average by 10%”) to address or ameliorate the events satisfying the pre-defined criteria.

Certain embodiments will include aspects intended to enable post-treatment analysis of collections of workflow treatment records. With continued reference to FIG. 1, an operator of the system may decide to perform analytics on treatment records for patients having data records associated with the “pregnant” attribute. In this example, the operator indicates that, of all the markers present in all the workflows for “pregnant” patients, the operator is interested in data associated with patient registration, lab ordering, X-ray ordering, and patient departure. As illustrated in FIG. 1, the operator indicates this interest by interacting with the system to designate those four events to be “key” markers.

Once the key markers are designated, the collected workflow data for patients having the specified common attributes of interest can be analyzed. That analysis can include the computation of various statistics concerning the workflows: minimum times, maximum times, medians, modes, variance, durations, start times, stop times, etc. These statistics can be computed for an entire workflow, an individual marker, an arbitrary set of markers, an arbitrary portion of the workflow; any of the foregoing with respect to a particular staffer, patient of interest, sets of staffers, etc.

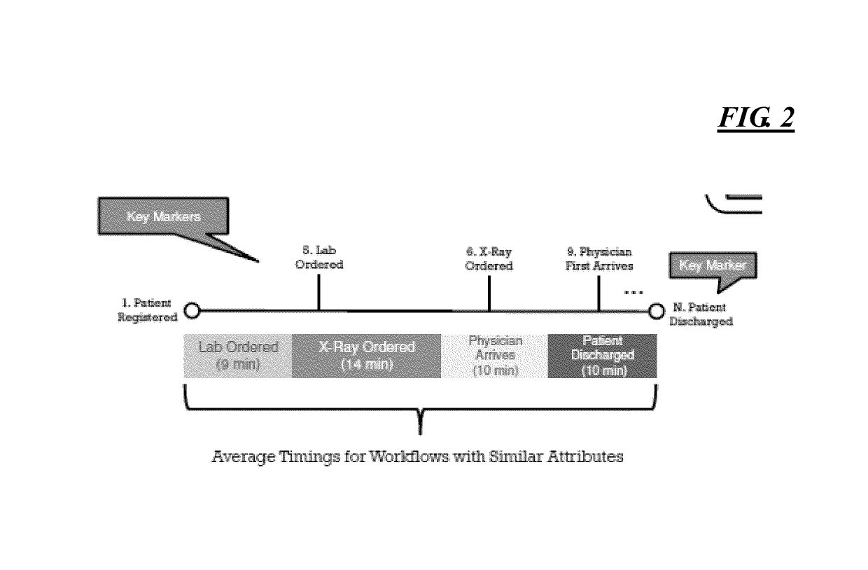

FIG. 2 illustrates an analysis on the key markers of FIG. 1 that graphically depicts the average time between each adjacent pair of key markers for patients having a specified attribute of interest. In this case, it took, on average, nine minutes from the patient's registration to the ordering of a lab, 14 minutes from the ordering of a lab to the ordering of an X-ray, 10 minutes from the ordering of the X-ray to the arrival of the physician, and 10 minutes from the arrival of the physician to the discharge of the patient.

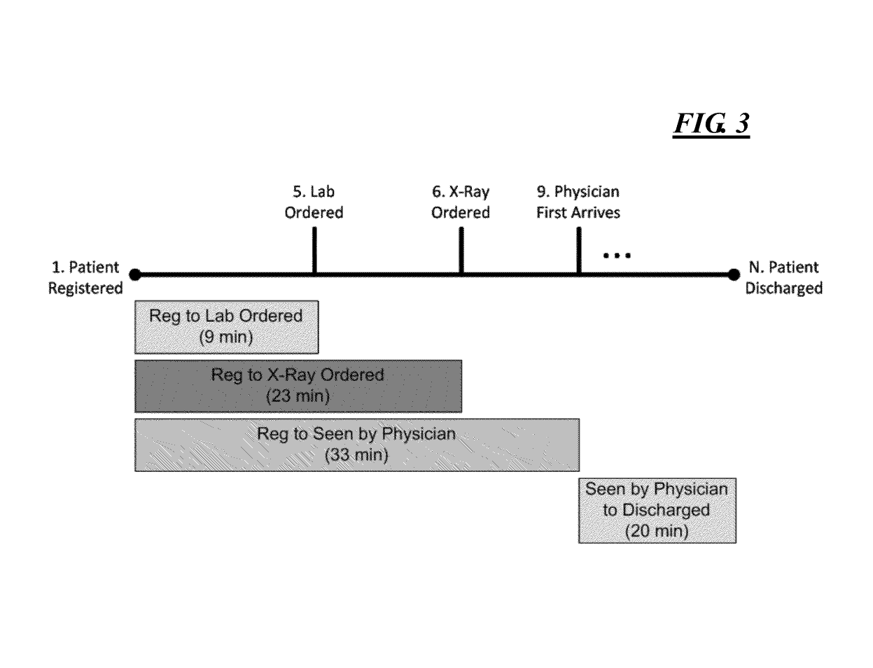

As discussed above and as illustrated in FIG. 3, an analysis may also be performed on non-adjacent key markers of FIG. 1. In this case, it took, on average, nine minutes from the patient's registration to the ordering of a lab, 20 minutes from the patient's registration to the ordering of an X-ray, and 33 minutes from the patient's registration to the time that the patient is seen by a physician.

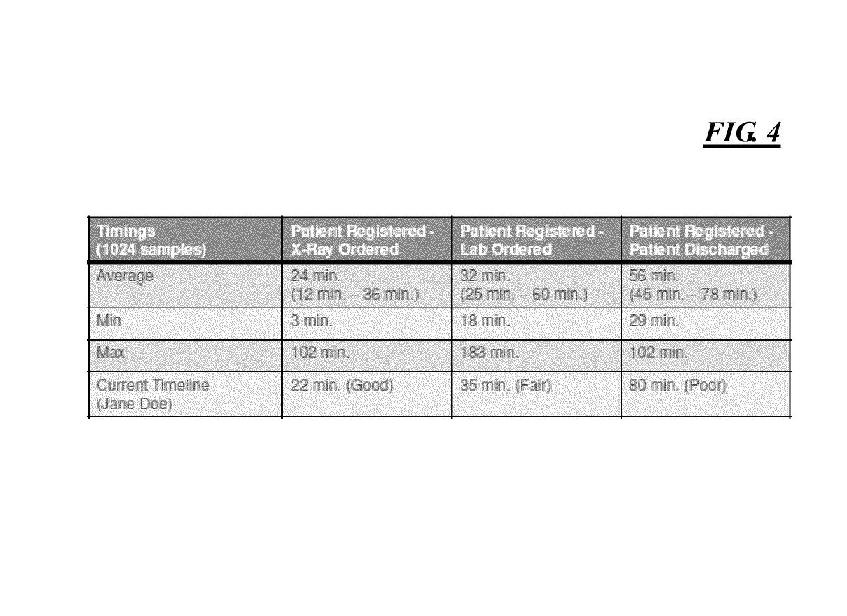

FIG. 4 illustrates another analysis showing the average time, the minimum time, and the maximum time between subset pairs of the key markers of FIG. 1 for patients having a common attribute of interest. For example, it took, on average, 32 minutes from a patient's registration to the ordering of lab work; the times for visits falling within one standard deviation of the average range from 25-60 minutes. The minimum amount of time between that pair of key markers is 18 minutes, while the maximum amount of time between that pair of key markers is 183 minutes.

FIG. 4 also depicts the ability of embodiments of the present invention to compare an individual patient's workflow in real time against historical data for similar workflows for patients having similar attributes. In this example, “Good” means that the time to the key marker is less than the average time; “Fair” means that the time is over average but within two standard deviations; “Poor” means that the time is over average and outside two standard deviations; and “Urgent” means that the time exceeds the historical maximum value. As illustrated, Jane Doe's workflow indicates that, while the time before ordering X-rays and labs was in line with historical expectation, her overall treatment took longer than would have been expected.

The collected workflow data can be used to determine whether there is a particular order or sequence of events resulting in a shorter or more efficient treatment sequence. The system can passively collect treatment workflow data from the facility in its normal course of operation, or it can actively intervene in the workflow scheduling process by, e.g., permuting the order of various steps in the workflow to ensure that the treatment workflow data is more representative of the entire treatment workflow space. Those changes can be effected by, e.g., changing the patient's treatment schedule at registration or after certain events, sending messages to an individual patient altering a schedule or redirecting the patient, etc. The collected workflow data can also be used to compare workflow performance among multiple facilities.

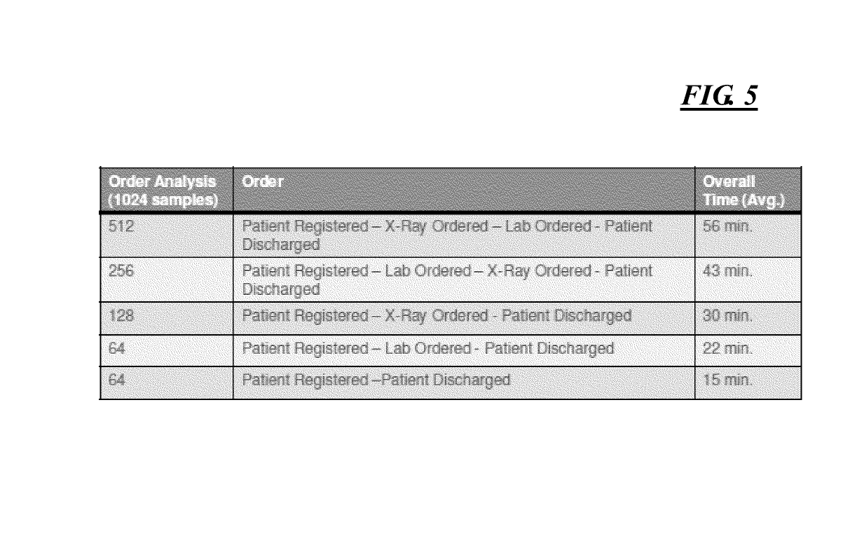

FIG. 5 shows an analysis of workflows for a plurality of patients having attributes of interest in accord with the present invention. Of 1024 workflows, half of them had the marker order “Patient Registered,” followed by, “X-Ray Ordered,” followed by “Lab Ordered,” followed by “Patient Discharged.” The other half of the workflows include some variation of that order, including certain workflows for patients having one or more attributes of interest, but lacking one or more key markers of interest.

In this case, the workflow data indicate that it is more efficient, i.e., faster to order labs before X-rays instead of ordering X-rays before labs. This insight can be manually incorporated into treatment workflows for patients having matching attributes or, in accord with the present invention, treatment workflows for patients having matching attributes can be automatically scheduled to follow this ordering of events.

As discussed above, further embodiments of the system account monitor treatment workflow performance in real time and can account for workflow impediments by reassigning personnel, reassigning patients, rescheduling resources, and sending appropriate alerts to personnel, patients, and relevant third parties to achieve these ends. For example, if workflow monitoring indicates that a patient's surgery is running later than expected, subsequent surgeries involving the same surgeon can be rescheduled. That rescheduling can also involve rebooking operating rooms and updating the patient and the patient's family as to the changes in time and place. Similarly, if the system determines that the backlog of patients at a certain marker has exceeded a certain threshold, the system may reschedule the treatment workflow for some or all of those patients to work around that backlog, even if that rescheduling may run contrary to what is normally the preferred order for treatment.

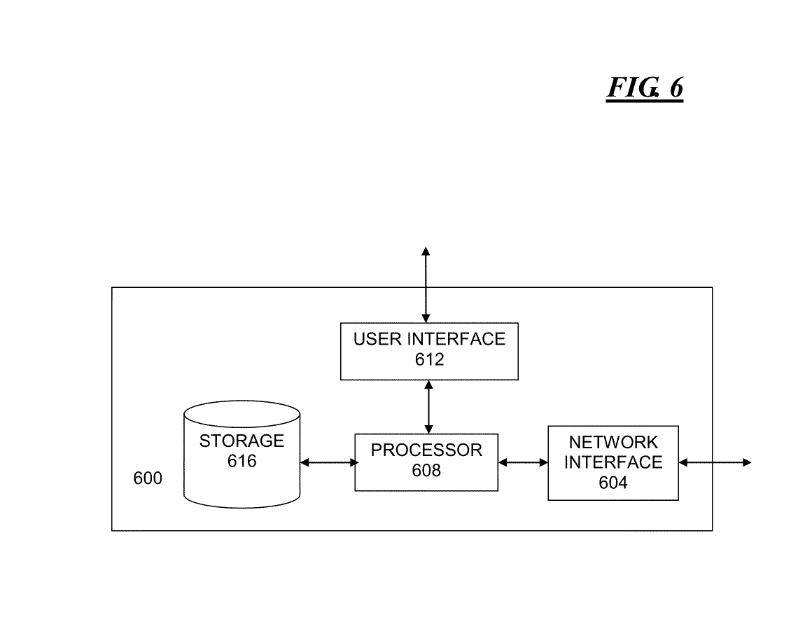

FIG. 6 describes an exemplary analytics device 600 in additional detail. The analytics device 600 may be a dedicated server or other computer containing appropriate software in a persistent memory and one or more of the components depicted in FIG. 6.

The network interface 604 allows the analytics device 600 to transmit communications to other devices and, in one embodiment, provides an interface to a local area network or wide area network such as the Internet. Suitable network interfaces 604 include gigabit Ethernet, Wi-Fi (802.11a/b/g/n), Bluetooth, and 3G/4G wireless interfaces such as GSM/WCDMA/LTE that enable data transmissions between analytics device 600 and other devices such as, e.g., the active or passive tracking devices carried by a patient or another analytics device 600′.

A processor 608 processes data relating to patient healthcare workflows, generates communications for transmission through the interface 604, and processes communications received through the interface 604 that originate outside the analytics device 600. A typical processor 608 is an x86, x86-64, or ARMv7 processor, and the like.

The user interface 612 allows the analytics device 600 to receive commands from and/or provide feedback an operator; one particular form of feedback involves the presentation of interactive graphic elements on a touch-sensitive screen (LCD, LED, etc.). Other exemplary user interfaces include graphical displays, physical keyboards, virtual keyboards, etc.

Storage 616 provides both transient and persistent storage for data conveyed via the interface 604, data processed by the processor 608, data received or sent via the user interface 612 and other forms of data handled by the analytics device 600.

As discussed above, the analytics device 600 is configured to collect data concerning various events occurring in a patient healthcare workflow. The data collection process involves the analytics device 600 interacting with various mechanisms, both passive and active, to track individual patients (temporally, physically, etc.) as they receive treatment in a medical facility.

An operator can specify various markers of interest in a workflow before data collection, after data collection, contemporaneously with data collection, etc. Once markers are specified, the analytics device 600 can develop various metrics with respect to one or more markers, compare those metrics against historic values or desired values and display the results of such comparison, send communications or take other actions in response to such analytics, etc.

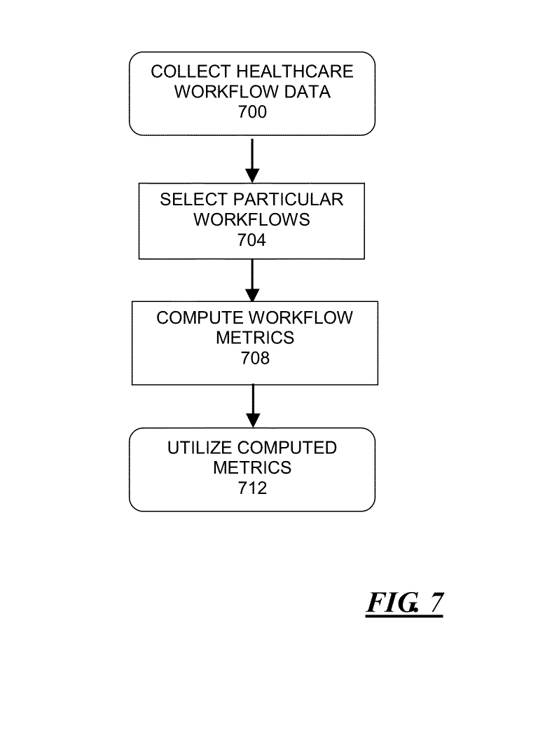

FIG. 7 presents a flowchart describing a method for healthcare workflow analytics in accord with the present invention. Healthcare workflow data is collected, as discussed above (Step 700). An operator of the system specifies the key markers of interest and, optionally, attributes to select particular workflows of interest (Step 704). Metrics are computed for the selected workflows (Step 708) and used to identify workflow impediments and adjust workflows, current and future.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed.

For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A method for analyzing healthcare workflow data, the method comprising:
collecting, via a network interface, healthcare workflow data comprising at least one workflow, each workflow associated with a patient, each patient associated with at least one attribute;
receiving, through a user interface, at least one specified attribute; and
selecting, from the collected plurality of workflows, each workflow of the plurality associated with a patient having the at least one specified attribute.

2. The method of claim 1, wherein each workflow comprises at least two markers.

3. The method of claim 2, further comprising receiving, through a user interface, at least two specified markers.

4. The method of claim 3, further comprising computing at least one metric between two specified markers.

5. The method of claim 4, further comprising comparing the at least one computing metric against a threshold value.

6. The method of claim 5, wherein the threshold value is selected from the group consisting of a normative value and a specified value.

7. The method of claim 4, further comprising recommending a change to at least one workflow based on the comparison.

8. The method of claim 1, further comprising storing the collected healthcare workflow data in a persistent electronic memory.

9. The method of claim 1, further comprising comparing at least two of the selected plurality of workflows.

10. The method of claim 2 wherein the markers are selected from the group consisting of a time, a place, and a location.

11. An apparatus for analyzing healthcare workflow data, the apparatus comprising:
a network interface for transmitting and receiving electronic communications;
a user interface for accepting user input and providing output to an operator;
a processor communicatively coupled to the user interface and the network interface and configured to execute instructions from a storage to:
collect, via the network interface, healthcare workflow data comprising at least one workflow, each workflow associated with a patient, each patient associated with at least one attribute;
receive, through a user interface, at least one specified attribute; and
select, from the collected plurality of workflows, each workflow of the plurality associated with a patient having the at least one specified attribute.

12. The apparatus of claim 11, wherein each of the collected workflows comprises at least two markers.

13. The apparatus of claim 12, wherein the processor is further configured to execute instructions from the storage to receive, through a user interface, at least two specified markers.

14. The apparatus of claim 13, wherein the processor is further configured to execute instructions from the storage to compute at least one metric between two specified markers.

15. The apparatus of claim 14, wherein the processor is further configured to execute instructions from the storage to compare the at least one computed metric against a threshold value.

16. The apparatus of claim 15, wherein the threshold value is selected from the group consisting of a normative value and a specified value.

17. The apparatus of claim 14, wherein the processor is further configured to execute instructions from the storage to recommend a change to at least one workflow based on the comparison.

18. The apparatus of claim 11, wherein the processor is further configured to execute instructions from the storage to store the collected healthcare workflow data in a persistent electronic memory.

19. The apparatus of claim 11, wherein the processor is further configured to execute instructions from the storage to compare at least two of the selected plurality of workflows.

20. The apparatus of claim 12 wherein the markers are selected from the group consisting of a time, a place, and a location.
